(19) United States
(12) Patent Application Publication
(10) Pub. No.: US 2011/0217554 A1
(43) Pub. Date: Sep. 8, 2011

(54) PHENOLIC RESIN FOR SHELL MOLDING, PROCESS FOR PRODUCING THE SAME, RESIN COATED SAND FOR SHELL MOLDING, AND SHELL MOLD FORMED OF THE SAME

(75) Inventors: Keiichi MORI, Niwa-gun (JP); Tomohiro TAKAMA, Niwa-gun (JP)

(73) Assignee: Asahi Organic Chemicals Industry Co., Ltd., Nobeoka-shi (JP)

(21) Appl. No.: 13/106,948

(22) Filed: May 13, 2011

Related U.S. Application Data
(63) Continuation of application No. PCT/JP2009/006634, filed on Dec. 4, 2009.

(30) Foreign Application Priority Data
Dec. 12, 2008 (JP) 2008-317113

(51) Int. Cl. C08G 8/04; B32B 5/16

(52) U.S. Cl. 428/403; 528/144; 528/138; 528/139

(57) ABSTRACT

A phenolic resin for shell molding is provided which generates less tar during casting and has low thermal expansion properties and high flexibility. Further, a process for producing the phenolic resin, RCS obtained by using the phenolic resin, and a shell mold obtained by using such RCS are provided.

A phenolic resin having advantageous characteristics is obtained by reacting phenols and naphthols with aldehydes in the presence of at least one of divalent metal salt and oxalic acid which acts as catalyst.

This application is a continuation of the International Application No. PCT/JP2009/006634 filed Dec. 4, 2009, which claims the benefit under 35 U.S.C. §119(a)-(d) of Japanese Patent Application 2008-317113, filed Dec. 12, 2008, the entireties of which are incorporated herein by reference.

### TECHNICAL FIELD

The present invention relates to a phenolic resin for shell molding, process for producing the same, a resin coated sand for shell molding, and a shell mold formed of the same. In particular, the present invention relates to a phenolic resin for shell molding which restricts a generation of a pyrolysis product (hereinafter simply referred to as “tar”) generated at a time of casting and which is useful to simultaneously solve a problem related to thermal expansion and flexibility. The present invention also relates to a process for producing the phenolic resin, a resin coated sand obtained by using the phenolic resin, and a shell mold obtained by using the resin coated sand.

### BACKGROUND ART

Conventionally, in shell-mold casting, there is generally used a shell mold that is formed by using resin coated sands obtained by kneading fire-refractory particles (casting sand), a phenolic resin (binder) and as necessary a hardener such as hexamethylenetetramine, and by hot-forming the resin coated sands into a desired shape. Hereinafter, the resin coated sand is referred to as “RCS”.

However, in casting process by using this kind of molds, especially by using a mold which has a complex configuration, e.g., a mold for casting a molded product such as a cylinder head of an internal combustion engine, there is a problem that a fracture or a crack (hereinafter referred to as “crack” of the mold) is easily caused on the mold during the casting process using the mold. In addition, there is a recent trend that the configuration of a mold is increasingly complex, while a number of vents for gas purging is decreased. As a result, a generation of tar caused by the binder during casting has also been a serious problem.

Meanwhile, it is thought that the crack of a mold can be prevented by lowering coefficient of thermal expansion and increasing the flexibility of the mold. Accordingly, Patent document 1 discloses that coefficient of rapid thermal expansion is lowered by using bisphenols such as bisphenol A and bisphenol E as a component of binder, thereby obtaining low thermal expansion properties. However, although such method has sufficiently solved the problem of crack of the mold, an amount of tar generated during the casting is increased. As a result, there is newly caused a problem that casting defect (gas defect, for example) is easily caused.

Patent document 2 proposes a method in which crack of the mold is prevented by incorporating polyethylene glycol having a number average molecular weight of 1500-40000 into RCS. However, thermal expansion properties and flexibility are not sufficiently improved by this method, and thus further improvement is needed.

Patent document 3 discloses that by using RCS formed by coating a surface of the casting sand with phenolic resin excellent in collapse resistance, which is produced by using at least naphthols as phenols, the improvement of regeneration rate of the used shell sand and the stability of quality, of the regenerated sand can be obtained because collection of a mass of shell after molding is improved. In examples of patent document 3, phenolic novolak resin and phenolic resole resin are exemplified which are obtained by reacting α-naphthol or β-naphthol, or a combination of the naphthols and phenol, with formalin in the presence of catalyst such as hydrochloric acid and ammonia water. However, particularly in the production of such resin by using hydrochloric acid as a catalyst, there is a safety problem caused by the vigorous reaction during the production of the resin, and also there is a problem of corrosion of a die during the production of the mold. Further, patent document 3 is silent about phenolic resin obtained by using oxalic acid as a catalyst and RCS obtained by using the same. Furthermore, it is also silent about a crack of a mold, and generation of tar, which should be considered when producing a mold.
Patent Document 1: JP-A-59-178150
Patent Document 2: JP-A-58-119433
Patent Document 3: JP-A-63-30144

### SUMMARY OF THE INVENTION

The present invention has been made in the light of the situations described above. It is therefore an object of the present invention to provide: a phenolic resin for shell molding that generates less tar during casting and has low thermal expansion properties and high flexibility: a process for producing the phenolic resin: RCS obtained by using the phenolic resin: and a shell mold obtained by using such RCS.

The inventors of the present invention have conducted intensive study and research about the phenolic resin for shell molding in an effort to solve the above-described problems and found that phenolic resin having effective properties can be obtained by reacting phenol components including phenols and naphthols with aldehydes in the presence of a reaction catalyst such as divalent metal salt and/or oxalic acid. Specifically, they found that in the mold produced by using RCS formed by using the above-described phenolic resin, the generation of tar is reduced and low coefficient of thermal expansion and high flexibility are obtained. Thus, the present invention has been completed.

It is therefore an object of the present invention to provide a phenolic resin for shell molding obtained by reacting phenols and naphthols with aldehydes in the presence of at least one of divalent metal salt and oxalic acid which acts as catalyst.

According to a preferable aspect of the phenolic resin for shell molding of the present invention, a reaction molar ratio among the phenols (P), the naphthols (N) and the aldehydes (F): F/(P+N) is in a range of from 0.40 to 0.80.

According to another preferable aspect of the present invention, the naphthols is 1-naphthol or 2-naphthol, and a ratio of phenols to naphthols is controlled to be in a range of from 95:5 to 50:50 by mass ratio.

According to a further preferable aspect of the phenolic resin for shell molding of the present invention, a number average molecular weight thereof is in a range of from 400 to 1300.

It is another object of the present invention to provide RCS (resin coated sand) for shell molding, in which fire-refractory particle is coated with the phenolic resin for shell molding according to the above.

According to a preferable aspect of RCS for shell molding of the present invention, the phenolic resin is present in a range of from about 0.2 parts by mass to about 10 parts by mass based on 100 parts by mass of the fire-refractory particles.

It is still another object of the present invention to provide a shell mold obtained by forming and heat-curing the above-described RCS for shell molding.

It is still further object of the present invention to provide a process for producing a phenolic resin for shell molding, comprising: reacting at least one phenols and at least one naphthols with at least one aldehydes in the presence of at least one of divalent metal salt and oxalic acid which acts as catalyst.

According to a preferable aspect of the process for producing a phenolic resin of the present invention, the catalyst is used in an amount of 0.01-5 parts by mass based on 100 parts by mass of the total of the at least one phenols and the at least one naphthols.

According to another preferable aspect of the present invention, the divalent metal salt is selected from the group consisting of lead naphthenate, zinc naphthenate, lead acetate, zinc acetate, zinc borate, lead oxide, and zinc oxide.

The phenolic resin for shell molding according to the present invention is obtained by reacting naphthols and phenols with aldehydes in the presence of a specific catalyst comprising divalent metal salt and/or oxalic acid. Therefore, when a coating layer comprised thereby is formed on a surface of a predetermined fire-refractory particle to constitute RCS for shell molding and a shell mold is produced by using such RCS, an amount of tar generated from the mold can be advantageously reduced. Further, at the same time, the obtained mold has low thermal expansion properties and the flexibility of the mold can be sufficiently improved. Accordingly, a problem of gas defect caused by the generation of tar during the casting and a problem of casting defect of veining caused by a crack of the mold can be solved at the same time. In addition, since a corrosive component such as hydrochloric acid is not included, the present invention can have industrial advantages. For example, a resin which does not corrode a die during mold-forming can be easily and safely produced.

### BRIEF DESCRIPTION OF THE DRAWING

FIG. 1 is a view for explaining a form of measuring the “flexibility” of the mold which is measured in EXAMPLES.

### DETAILED DESCRIPTION OF THE INVENTION

The phenolic resin for shell molding according to the present invention is obtained by reacting phenols and naphthols with aldehydes in the presence of a specific catalyst comprising divalent metal salt and/or oxalic acid.

Here, conventionally known one can be used as phenols, which is one of reaction components to provide a phenolic resin. Examples thereof include phenol, alkylphenols such as cresol, xylenol, p-tert-butylphenol and nonylphenol, polyhydric phenols such as resorcinol, bisphenol F and bisphenol A, and a mixture thereof. Any one of, or any combination thereof may be used.

The present invention is characterized by that naphthols are used as a phenol component together with the phenols. Due to this characteristic, the properties of the phenolic resin to be obtained is effectively improved. Preferred examples of naphthols include 1-naphthol, 2-naphthol and a mixture thereof in terms of its ready availability and a reduction of cost, for example. Preferably, 1-naphthol is employed, in terms of its excellence in reacting with aldehydes and a reduction of an amount of tar. The phenols and naphthols are employed such that the ratio of phenols to naphthols (1-naphthol or 2-naphthol) is in a range of from 95:5 to 50:50 by mass ratio. In other words, naphthols are employed so as to be present in an amount of 50% by mass or less, based on the total phenol component. When the amount of naphthols is more than 50% by mass, an amount of generation of tar during casting may be increased. On the other hand, when the amount of naphthols is less than 5% by mass, flexibility may be deteriorated. The ratio of phenols to naphthols is preferably in a range of from 90:10 to 60:40, more preferably from 90:10 to 70:30.

Examples of the aldehydes, which is reacted with the above described phenols and naphthols to obtain the phenolic resin of the present invention, include formalin, paraformaldehyde, trioxan, acetaldehyde, paraldehyde, and propionaldehyde. It is to be understood that the aldehydes are not limited to the above examples, and other well-known materials may be suitably used. Further, any one of, or any combination of the aldehydes may be used.

In the present invention, in order to obtain the intended phenolic resin by reacting the phenols (P) and naphthols (N) with aldehydes (F), it is recommended that the phenols and naphthols are reacted with aldehydes such that the blending molar ratio: F/(P+N) is in a range of 0.40 to 0.80. By controlling the blending molar ratio: F/(P+N) so as to be 0.75 or less, more preferably 0.70 or less, the flexibility can be further improved. In addition, by controlling the value of F/(P+N) so as to be 0.40 or more, the intended phenolic resin can be produced with a sufficient yield, and by controlling the value of F/(P+N) so as to be 0.80 or less, the strength of the mold which is obtained by using RCS for shell molding produced by using thus obtained phenolic resin can be advantageously improved.

The present invention is also characterized by that at least one of divalent metal salt and oxalic acid is/are used as a specific catalyst in the reaction of phenols and naphthols with aldehydes. By using such a specific catalyst, an amount of tar to be generated, coefficient of thermal expansion and flexibility can be further improved. Examples of the divalent metal salts include metal salts having divalent metal element, such as lead naphthenate, zinc naphthenate, lead acetate, zinc acetate, zinc borate, lead oxide, and zinc oxide, and a combination of acidic catalyst and basic catalyst which can form the metal salt. Among the specific catalysts, oxalic acid is preferably used in terms of reduction of generation of tar. Generally, the catalyst comprising at least one selected from a group consisting of divalent metal salts and oxalic acid is present in an amount of 0.01-5 parts by mass, preferably 0.05-3 parts by mass, based on 100 parts by mass of the total of phenols and naphthols.

The reaction of phenols and naphthols with aldehydes in the presence of the above-described catalyst is conducted in the same manner as a conventional production method of phenolic resin. Thus obtained phenolic resin is in a solid or a liquid (for example, varnish or emulsion) form, and expresses a heat-curing or -hardning effect when it is heated in the presence or absence of a hardener or curing catalyst such as hexamethylene tetramine. In the present invention, a phenolic resin having a number average molecular weight as measured by gel permeation chromatography (GPC) in a range of from 400 to 1300 is preferably used. When the number average molecular weight of the phenolic resin is too small, a mold to be obtained may not have sufficient strength, because RCS for shell molding which is coated with resin composition including the phenolic resin have poor filling properties in mold-forming. On the other hand, when the number average molecular weight of the phenolic resin is too big, a mold to be obtained may not have sufficient strength, because flowability of resin during heating is deteriorated.

In the present invention, in order to use the phenolic resin in shell molding, various conventionally known additives can be previously added to the phenolic resin for the purpose of improving the physical characteristics of the mold, for example. Examples of the additives, which are advantageously employed, include silane coupling agents such as γ-aminopropyltriethoxysilane and γ-glycidoxypropyltrimethoxysilane, and lubricants such as ethylenebis(stearyramide) and methylenebis(stearyramide).

In the production of RCS for shell molding according to the present invention, fire-refractory particles are kneaded into the above-described phenolic resin for shell molding. Because an amount of the phenolic resin for shell molding in RCS of the present invention is determined by considering a kind of resin to be used, strength of the intended mold and so on, the amount thereof is not necessarily limited. However, the phenolic resin is generally present in a range from about 0.2 parts by mass to about 10 parts by mass, preferably 0.5 parts by mass to 8, parts by mass, more preferably 0.5 to 5 parts by mass, based on 100 parts by mass of the fire-refractory particles.

In the present invention, the kind of fire-refractory particles kneaded into the phenolic resin for shell molding is not particularly limited. As the fire-refractory particle is a basic material for a mold, any known inorganic particles conventionally used in the shell mold casting may be used as long as they have fire resistance suitable for casting and particle diameter suitable for forming a mold (mold-forming). In addition to silica sand which is commonly used, examples of the fire-refractory particles include, special sands such as olivine sand, zircon sand, chromite sand and alumina sand, slag particles such as ferrochromium slag, ferronickel slag and converter slag, mullite-based sand particles such as Naigai Cerabeads (commercial name, available from ITOCHU CERATECH CORP.), and regenerated particles which are obtainable by recovering and regenerating the above particles after casting. Any one of, or any combination of them can be used.

In the production of RCS for shell molding, examples of the production method include, but are not limited to, any conventional methods such as dry-hot-coating, semi-hot-coating, cold-coating, and powder-solvent coating. In the present invention, a so-called dry-hot-coating is preferably recommended, which is conducted by the steps of kneading preheated fire-refractory particles and resin for shell molding in a mixer such as a whirl mixer or a speed mixer, adding aqueous hexamethylenetetramine (hardener) solution, converting an aggregated content into particles by being collapsed by cooling with an air blow, and adding calcium stearate (lubricant).

Further, when making a predetermined shell mold by using the above-described RCS for shell molding, the process for making or forming mold by heating is not particularly limited. Any known process may be advantageously employed. For example, a casting mold can be obtained by the steps of filling a forming die, which has a shape corresponding to an intended shell mold and is heated to 150-300° C., with the above-described RCS by a gravity-driven method or blowing method, curing the RCS, and removing the cured (hardened) mold from the forming die. The mold obtained as above advantageously has the above-mentioned excellent effect.

### EXAMPLES

To further clarify the concept of the present invention, some examples of the invention will be described. It is to be understood that the invention is not limited to the details of the illustrated examples and the foregoing description, but may be embodied with various changes, modifications and improvements, which may occur to those skilled in the art without departing from the scope of the invention defined in the attached claims.

Here, “parts” and “%” in the following description refer to “parts by mass” and “% by mass”, unless otherwise indicated. In addition, characteristics of the produced RCS for shell molding are measured in accordance with the following test methods.

—Measurement of Amount of Generated Tar—

Four test pieces (size: 10 mm×10 mm×60 mm) for the measurement of the strength of the mold were placed in a test tube (internal diameter: 27 mm×length: 200 mm). Then, previously weighed glass wool (2.5 g) was inserted into the test tube and placed near an opening of the test tube, thereby preparing a measuring device to measure an amount of generated tar. The measuring device was inserted into a tubular furnace, in which a temperature was kept at 700° C., and the measuring device was heated for six minutes. Subsequently, the measuring device was taken out of the furnace, and left until it was cooled to a room temperature. Then, the glass wool was taken out of the measuring device and a mass of the glass wool was measured. The amount of the generated tar (mg) of each of the test pieces was calculated by deleting the mass (mg) of the glass wool before the heating from the mass (mg) of the glass wool after the heating.

—Evaluation of Flexibility of Mold—

Initially, pieces (120 mm×40 mm×5 mm) of molds made of each kinds of RCS were prepared under a cure condition: at 250° C. for 40 seconds, for the evaluation of flexibility of the molds. Then the pieces of the molds were left until it was cooled to a room temperature.

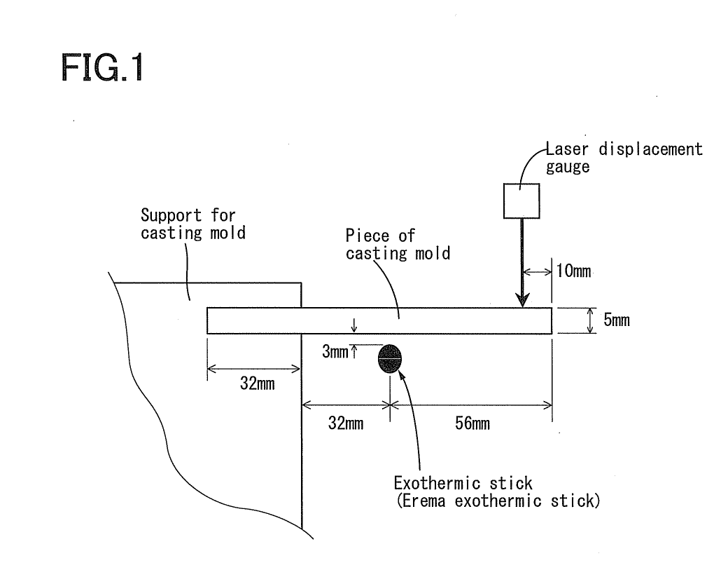

Subsequently, thus obtained piece of the mold was set on a support as shown in FIG. 1, and an exothermic stick (Erema exothermic stick) was gradually heated from 200° C. to 800° C. Meanwhile, a laser displacement gauge was positioned 10 mm away from an end portion of the piece of the mold, and data thereof was directly entered into a computer. Behaviors with respect to the displacement are as follows: at first the piece of the mold is warped due to an expansion behavior caused by the heating of the mold; then the piece is started to be bended; and finally, the piece is fractured at practically the center thereof, i.e., at the position heated by the exothermic stick. The term “flexibility” used herein is expressed by the maximum deflection obtained before the piece of the mold was fractured. As the value of the flexibility of the mold increases, the mold is easily deformed, which means that the mold is flexible. This measurement was conducted in consideration of measurement cycle such that the next measurement of a piece of the mold starts when the temperature of the exothermic stick is reached around 200° C.

—Evaluation of Coefficient of Thermal Expansion—

Evaluation of coefficient of thermal expansion was conducted according to a test method of rapid coefficient of thermal expansion specified in JACT test method M-2, test method of coefficient of thermal expansion. A test piece (28.3 mmφ×51 mL, cut into about ¼ of circumference) produced by heating a piece of mold at a temperature of 280° C. for 120 seconds was placed in a high-temperature casting sand tester controlled at 1000° C. and was taken out from it after 1 minute. A coefficient of thermal expansion was calculated by using the lengths of test piece before the heating and after the heating according to the following formula.

A coefficient of thermal expansion(%)={length of test piece(after heating−before heating)}/(length of test piece before heating)×100

### Production Example 1

To a reaction vessel provided with a thermometer, a stirring device, and a condenser, 800 parts of phenol, 200 parts of 1-naphthol, 411 parts of 47% formalin, 3 parts of oxalic acid were charged. Subsequently, a temperature in the reaction vessel was gradually raised to a reflux temperature and the mixture was subjected to a reaction under reflux condition for 90 minutes. Further, the mixture was dehydrated under ordinary pressure and heated under reduced pressure until the temperature reached 180° C. Accordingly, unreacted phenol was removed and phenolic resin 1 was obtained. The number average molecular weight of the phenolic resin 1 was 850.

### Production Example 2

Phenolic resin 2 was obtained in the same way as Production Example 1 with the exception that 950 parts of phenol, 50 parts of 1-naphthol, 434 parts of 47% formalin and 3 parts of oxalic acid were charged.

### Production Example 3

Phenolic resin 3 was obtained in the same way as Production Example 1 with the exception that 700 parts of phenol, 300 parts of 1-naphthol, 395 parts of 47% formalin and 3 parts of oxalic acid were charged.

### Production Example 4

Phenolic resin 4 was obtained in the same way as Production Example 1 with the exception that 500 parts of phenol, 500 parts of 1-naphthol, 253 parts of 47% formalin and 2 parts of oxalic acid were charged.

### Production Example 5

Phenolic resin 5 was obtained in the same way as Production Example 1 with the exception that 800 parts of phenol, 200 parts of 2-naphthol, 411 parts of 47% formalin and 3 parts of oxalic acid were charged.

### Production Example 6

Phenolic resin 6 was obtained in the same way as Production Example 1 with the exception that 800 parts of phenol, 100 parts of 1-naphthol, 100 parts of 2-naphthol, 411 parts of 47% formalin and 3 parts of oxalic acid were charged.

### Production Example 7

Phenolic resin 7 was obtained in the same way as Production Example 1 with the exception that 800 parts of phenol, 200 parts of 1-naphthol, 474 parts of 47% formalin and 3 parts of oxalic acid were charged.

### Production Example 8

Phenolic resin 8 was obtained in the same way as Production Example 1 with the exception that 800 parts of phenol, 200 parts of 1-naphthol, 411 parts of 47% formalin and 2 parts of zinc acetate were charged.

### Production Example 9

Phenolic resin 9 was obtained in the same way as Production Example 1 with the exception that 800 parts of phenol, 200 parts of 1-naphthol, 411 parts of 47% formalin and 2 parts of zinc naphthenate were charged.

### Production Example 10

Phenolic resin 10 was obtained in the same way as Production Example 1 with the exception that 800 parts of phenol, 200 parts of 1-naphthol, 411 parts of 47% formalin and 2 parts of zinc oxide were charged.

### Production Example 11

Phenolic resin 11 was obtained in the same way as Production Example 1 with the exception that 1000 parts of phenol, 441 parts of 47% formalin and 3 parts of oxalic acid were charged.

### Production Example 12

Phenolic resin 12 was obtained in the same way as Production Example 1 with the exception that 200 parts of phenol, 800 parts of bisphenol A (BPA), 234 parts of 47% formalin and 3 parts of oxalic acid were charged.

### Production Example 13

Phenolic resin 13 was obtained in the same way as Production Example 1 with the exception that 800 parts of phenol, 200 parts of 1-naphthol, 411 parts of 47% formalin and 1 part of aqueous 10% hydrochloric acid solution were charged.

### Production Example of RCS

To a laboratory whirl mixer, 7000 parts of fire-refractory particle (regenerated silica sand) heated to 130-140° C. and 105 parts of the phenolic resin obtained according to the above production examples 1 to 13, respectively, were added and kneaded for 60 seconds. After 23 parts of hexamethylenetetramine dissolved in 105 parts of water was added thereto and cooled by an air blow, 7 parts of calcium stearate was added. As a result, RCS for shell molding produced by using each of the phenolic resins of the above examples was obtained.

### EVALUATION

According to the test method described above, each RCS obtained as above was subjected to the measurement of amount of generated tar, the evaluation of flexibility of the mold, and the evaluation of coefficient of thermal expansion of the mold. The results thereof are shown in the following Table 1 and Table 2, together with the production condition of phenolic resin.

TABLE 1

| | | phenolic resin | | | | | |
|---|---|---|---|---|---|---|---|
| production condition | | 1 | 2 | 3 | 4 | 5 | 6 |
| amount | Phenol | 800 | 950 | 700 | 500 | 800 | 800 |
| (part) | BPA | — | — | — | — | — | — |
| | 1-naphthol | 200 | 50 | 300 | 500 | — | 100 |
| | 2-naphthol | — | — | — | — | 200 | 100 |

| molar ratio F/(P + N) | 0.65 | 0.65 | 0.65 | 0.45 | 0.65 | 0.65 |
|---|---|---|---|---|---|---|
| catalyst | oxalic acid | | | | | |
| tar (mg) | 70 | 68 | 76 | 83 | 81 | 78 |
| coefficient of thermal expansion (%) | 0.73 | 0.79 | 0.72 | 0.69 | 0.77 | 0.76 |
| 1000° C. × 1 min | | | | | | |
| flexibility (mm) | 7.2 | 5.0 | 12.8 | 13.7 | 8.4 | 7.2 |

TABLE 2

| | | phenolic resin | | | | | | |
|---|---|---|---|---|---|---|---|---|
| production condition | | 7 | 8 | 9 | 10 | 11 | 12 | 13 |
| amount | Phenol | 800 | 800 | 800 | 800 | 1000 | 200 | 800 |
| (part) | BPA | — | — | — | — | — | 800 | — |
| | 1-naphthol | 200 | 200 | 200 | 200 | — | — | 200 |
| | 2-naphthol | — | — | — | — | — | — | — |

| molar ratio F/(P + N) | 0.75 | 0.65 | 0.65 | 0.65 | 0.65 | 0.65 | 0.65 |
|---|---|---|---|---|---|---|---|
| catalyst | oxalic acid | zinc acetate | zinc | zinc oxide | oxalic acid | | hydrochloric |
| | | | naphthenate | | | | acid |
| tar (mg) | 71 | 75 | 73 | 76 | 65 | 133 | 76 |
| coefficient of thermal expansion (%) | 0.75 | 0.74 | 0.73 | 0.71 | 1.03 | 0.73 | 0.84 |
| 1000° C. × 1 min | | | | | | | |
| flexibility (mm) | 6.3 | 7.6 | 7.9 | 8.2 | 2.9 | 6.0 | 3.7 |

As apparent from the results shown in Table 1 and Table 2, RCS obtained by using the phenolic resin 1 to 10 of the production examples 1 to 10 respectively, which is according to the present invention, has less generation of tar, low coefficient of thermal expansion, and high flexibility. On the other hand, RCS obtained by using the phenolic resin 11 of the production example 11, in which only phenol is used, has high coefficient of thermal expansion, and low flexibility. Further, RCS obtained by using the phenolic resin 12, in which bisphenol A is used together with phenol, have a problem that a lot of tar is generated. Furthermore, RCS obtained by using phenolic resin 13, in which hydrochloric acid is used as a reaction catalyst, has poor coefficient of thermal expansion and flexibility, compared to RCS obtained by using phenolic resin 1 of the production example 1, in which oxalic resin is used as a catalyst.

What is claimed is:

1. A phenolic resin for shell molding obtained by reacting phenols and naphthols with aldehydes in the presence of at least one of divalent metal salt and oxalic acid which acts as catalyst.

2. The phenolic resin for shell molding according to claim 1, wherein a reaction molar ratio among the phenols (P), the naphthols (N) and the aldehydes (F): F/(P+N) is in a range of from 0.40 to 0.80.

3. The phenolic resin for shell molding according to claim 1, wherein the naphthols is 1-naphthol.

4. The phenolic resin for shell molding according to claim 1, wherein the naphthols is 2-naphthol.

5. The phenolic resin for shell molding according to claim 1, wherein a ratio of phenols to naphthols is in a range of from 95:5 to 50:50 by mass ratio.

6. The phenolic resin for shell molding according to claim 1, wherein a number average molecular weight thereof is in a range of from 400 to 1300.

7. A process for producing a phenolic resin for shell molding, comprising: reacting at least one phenols and at least one naphthols with at least one aldehydes in the presence of at least one of divalent metal salt and oxalic acid which acts as catalyst.

8. The process for producing a phenolic resin for shell molding according to claim 7, wherein the catalyst is used in an amount of 0.01-5 parts by mass based on 100 parts by mass of the total of the at least one phenols and the at least one naphthols.

9. The process for producing a phenolic resin for shell molding according to claim 7, wherein the divalent metal salt is selected from the group consisting of lead naphthenate, zinc naphthenate, lead acetate, zinc acetate, zinc borate, lead oxide, and zinc oxide.

10. A resin coated sand for shell molding, wherein fire-refractory particle is coated with the phenolic resin for shell molding according to claim 1.

11. The resin coated sand for shell molding according to claim 10, wherein the phenolic resin is present in a range of from about 0.2 parts by mass to about 10 parts by mass based on 100 parts by mass of the fire-refractory particles.

12. A shell mold obtained by forming and heat-curing the resin coated sand for shell molding according to claim 10.
